(19) United States
(12) Patent Application Publication
(10) Pub. No.: US 2017/0186008 A1
(43) Pub. Date: Jun. 29, 2017

(54) METHODS AND APPARATUS FOR AUTHENTICATING AND AUTHORIZING SECONDARY ACCOUNTS

(71) Applicant: CA, Inc., New York, NY (US)

(72) Inventors: Rajendra Kumar Pachouri, Bangalore (IN); MOHAMMED MUJEEB KALADGI, Bangalore (IN); SHARATH LAKSHMAN KUMAR, Bangalore (IN); MAHESH MALATESH CHITRAGAR, Bangalore (IN); PRADEEP G. NAIR, Bangalore (IN)

(73) Assignee: CA, Inc., New York, NY (US)

(21) Appl. No.: 14/982,415

(22) Filed: Dec. 29, 2015

(51) Int. Cl. G06Q 20/40; G06Q 20/02; H04L 29/06

(52) U.S. Cl. CPC G06Q 20/4014; H04L 63/0838; G06Q 20/027

(57) ABSTRACT

A restriction request message, including a restriction for a secondary account, is received by a computer server from a user device via a network node that is outside of a secure authorization network. An authorization request message, including an identifier of the secondary account and a secondary password provided by a terminal that is communicatively coupled to a node of the authorization network, is received by the computer server via the authorization network. The secondary account is identified as being associated with a primary account based on the identifier included in the authorization request message. Authentication for a transaction between the terminal and the primary account is performed by the computer server based on the secondary password. An authorization response message for the transaction between the terminal and the primary account, based on the restriction for the secondary account, is transmitted from the computer server via the authorization network.

### FIELD

The present invention relates generally to electrical computers and digital processing systems, and more particularly, to interprogram communication for authentication and authorization.

### BACKGROUND

As user accounts are increasingly used in computer-based transactions, methods of controlling and managing such user accounts may become increasingly important. This may be of particular relevance when an account of one individual or entity is linked with an account of another individual or entity. For example, an employee or a dependent (e.g. child, student, etc.) may have a secondary account that is linked to a primary account of an employer or parent, respectively.

When accounts are so linked, the primary account holder (e.g. employer, parent, etc.) may wish to establish certain controls over the use of the linked account, particularly to the extent that the primary account holder is responsible for activity that is conducted using the secondary account. However, some existing methods of controlling usage of a linked account may be lacking with respect to security and/or convenience for the primary account holder.

### SUMMARY

Some embodiments described herein are directed to a computer server that is communicatively coupled to one of a plurality of nodes of a secure authorization network. The computer server includes a network interface, a processor coupled to the network interface, and a memory coupled to the processor. The memory includes a computer-readable storage medium storing computer-readable program code therein. When executed, the computer-readable program code causes the following operations to be performed by the processor of the computer server. A restriction request message, which includes a restriction for a secondary account, is received through the network interface from a user device via a network node that is outside of the secure authorization network. An authorization request message, which includes an identifier of the secondary account and a secondary password provided by a terminal that is communicatively coupled to one of the nodes, is received through the network interface via the secure authorization network. The secondary account is identified as being associated with a primary account based on the identifier included in the authorization request message. Authentication for an electronic transaction between the terminal and the primary account is performed based on the secondary password responsive to the identifying. An authorization response message for the electronic transaction between the terminal and the primary account, based on the restriction for the secondary account, is selectively transmitted through the network interface via the secure authorization network, responsive to the authentication based on the secondary password.

Some embodiments described herein are directed to a method, in which operations as follow are performed by a processor of a computer server that is communicatively coupled to one of a plurality of payment nodes of a secure payments network. In the method, a restriction request message that includes a monetary restriction for a secondary account is received by the computer server from a consumer device, via a network node that is outside of the payments network. A transaction authorization request message, including an identifier of the secondary account and a secondary password provided by a merchant terminal that is communicatively coupled to one of the payment nodes, is received by the computer server via the payments network. The secondary account is identified by the computer server as being associated with a primary account based on the identifier included in the transaction authorization request message. Authentication for an electronic transaction between the merchant terminal and the primary account is performed based on the secondary password by the computer server responsive to the identifying. An authorization response message for the electronic transaction between the merchant terminal and the primary account, based on the monetary restriction for the secondary account, is selectively transmitted from the computer server via the payments network responsive to the authentication based on the secondary password.

Some embodiments described herein are directed to a computer program product including a computer-readable storage medium having computer-readable program code embodied therein. When executed, the computer-readable program code causes the following operations to be performed by a processor of a computer server that is communicatively coupled to one of a plurality of payment nodes of a secure payments network. A restriction request message, which includes a monetary restriction for a secondary account, is received by the computer server from a consumer device via a network node that is outside of the payments network. A transaction authorization request message, including an identifier of the secondary account and a secondary password provided by a merchant terminal that is communicatively coupled to one of the payment nodes, is received by the computer server via the payments network. The secondary account is identified by the computer server as being associated with a primary account based on the identifier included in the transaction authorization request message. Authentication for an electronic transaction between the merchant terminal and the primary account is performed based on the secondary password by the computer server responsive to the identifying. An authorization response message for the electronic transaction between the merchant terminal and the primary account, based on the monetary restriction for the secondary account, is selectively transmitted from the computer server via the payments network responsive to the authentication based on the secondary password.

Other methods, computer servers, network nodes, and computer program products according to embodiments will be or become apparent to one with skill in the art upon review of the following drawings and detailed description. It is intended that all such additional methods, computer servers, network nodes, and computer program products, including any and all combinations of operations performed thereby, be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1A is a block diagram illustrating components of a computer system in accordance with some embodiments.

FIGS. 1B and 1C are flow diagrams illustrating operations performed by various components of the computer system of FIG. 1A in accordance with some embodiments.

FIGS. 2-6 are flowcharts illustrating operations performed by various components of a computer system in accordance with some embodiments.

FIG. 7 is a block diagram of a computer system that may be incorporated into various components of the computer system of FIG. 1A in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

As described herein, a computer server may include a computer or cluster of computers. For example, the computer server can be a large mainframe, a minicomputer cluster, or a group of servers functioning as a unit. In one example, the computer server may be coupled to a Web server. The computer server may be coupled to a database and may include hardware (including one or more processors, memory, etc.), software, or combinations thereof for servicing the requests from one or more client computers. The computer server may include one or more computational apparatuses and may use any of a variety of computing structures, arrangements, and compilations for servicing the requests from one or more client computers.

An issuer may refer to a business entity (e.g., a bank) that maintains an account (e.g., a monetary account, such as a bank account, payment account, etc.) for a consumer (also referred to herein as an account holder). The account may be associated with a portable payments device. A portable payments device may refer to a mobile communication device, such as a smartphone, tablet computer, or other consumer electronic device including a mobile payments application installed thereon, or may refer to a credit card, debit card, smart card, or other portable card. An issuer may also store and/or define account parameters associated with the account for use by the payments device. An issuer may be associated with an issuer computer server that performs some or all of the functions of the issuer, and/or an authorization computer server that performs at least some functions on behalf of the issuer.

A merchant may refer to an entity that engages in electronic transactions for goods or services. A merchant terminal may refer to a computer include a point-of-sale (POS) terminal, a point-of-banking (POB) terminal, an automated teller machine (ATM) terminal, and/or other terminal that is associated with the merchant and is operable to conduct a monetary transaction with a user/consumer account.

An acquirer may refer to a business entity (e.g., a commercial bank) that has a business relationship with a merchant or other entity. An acquirer may be associated with an acquirer computer server that performs some or all of the functions of the acquirer. In some embodiments, an acquirer may include one or more entities that can perform some issuer and acquirer functions.

Some embodiments described herein provide methods, devices, and systems for network-based electronic transactions that can be performed by a payments device with or without a hardware-based secure element. For example, EMV cards (which are smart cards which store data on integrated circuits rather than magnetic stripes) may be used for contactless payment when a physical card is present; however, some embodiments described herein can utilize card emulation technology (e.g., Host Card Emulation (HCE), etc.) to emulate a smartcard on a mobile communication device (e.g., a portable payments device) to allow a client application running on the payments device to conduct contactless transactions, where the EMV application can be stored on a cloud-based Secure Element (SE). In particular, a client application can access a contactless interface (e.g., a near-field communication (NFC) transceiver) of the payments device via the operating system (OS) of the payments device without involving a hardware-based secure element. For example, when a user presents a cloud-based card for transaction, NFC commands may be routed to an HCE client app for verification and authorization processing though a mobile application management platform (MAP), for instance, using the client app's Application Identifier (AID). The MAP in turn may connect to the issuer backend and payment system as needed to complete the transaction. The system may also include a cloud server managing the issuance of card data and cloud account lifecycle and a cloud transaction processor. A trusted tokenization system may be a shared resource that can be used to generate and de-tokenize tokens representing actual card data in the issuer backend. However, other embodiments described herein can be utilized with a contact-based or contactless smart card or fob that includes a hardware-based secure element therein. Still other embodiments described herein can be utilized with a credit/debit card that does not include a secure element therein, for example, a magnetic stripe-based card.

Embodiments described herein may arise from realization that a primary account holder of an account issued by an issuer (referred to herein as a primary account) may wish to allow another person or party to withdraw funds from the primary account, while retaining some element of control over the usage of the primary account. Conventionally, a primary account holder that wishes to allow family members or friends to withdraw money from a primary account may be required to share the primary account number/card and/or associated password with the family member/friend, which may present security risks. Moreover, the primary account holder conventionally may have no control over the amount that the family member/friend might charge to/debit from the account.

Accordingly, embodiments of the present invention enable parties with whom a primary account holder wishes to allow use of the primary account (referred to herein as secondary account holders of respective secondary accounts) to conduct electronic transactions with a merchant over a secure payments network using the primary account, but subject to monetary restrictions (and/or other transaction restrictions) for one or more secondary accounts, where the transaction restrictions are defined by the primary account holder via a network node that is outside of the secure payments network. For example, the primary account holder may define one or more transaction restrictions for the use of one or more secondary accounts, each of which may be a sub-account of the primary account, using a web-based portal or client application executing on a consumer device that is outside of (e.g., not authorized for access or communication with) the secure payments network.

In some embodiments, the primary account holder-defined monetary restriction (and/or other transaction parameters) for each secondary account can be determined from or is otherwise associated with a password (referred to herein as a secondary password), such as a one-time password (OTP). In particular, restriction specification and/or secondary password generation can be initiated by the primary account holder via a network node that is outside of the secure payments network, using a client application or web portal executing on a consumer electronic device, prior to initiation of a transaction with a merchant terminal by the secondary account holder. For example, the primary account holder may specify transaction restrictions including a monetary amount, particular location(s), particular merchant(s), particular number of uses, duration/times of use, and/or other transaction restrictions for each secondary account via the client application or web portal, and the account issuer (or associated third-party server) may generate a secondary password that is associated with those specific transaction details that were defined by the primary account holder. The secondary password may be transmitted to the device associated with the primary account holder and/or to a device associated with a secondary account holder via the client application or web portal or e-mail, thereby avoiding network-based delivery costs (e.g., SMS messaging charges). Upon subsequent receipt of the secondary password from a merchant terminal, the issuer/associated third-party server may recognize the secondary account identifier as being associated with the primary account, and may authorize the transaction with the merchant terminal for an amount that does not exceed the monetary restriction (and/or other transaction restrictions) associated with the secondary password. In some embodiments, a third-party server may perform operations for distinguishing between the primary and secondary account(s) such that the usage and/or existence of the secondary account(s) may be transparent to the issuer.

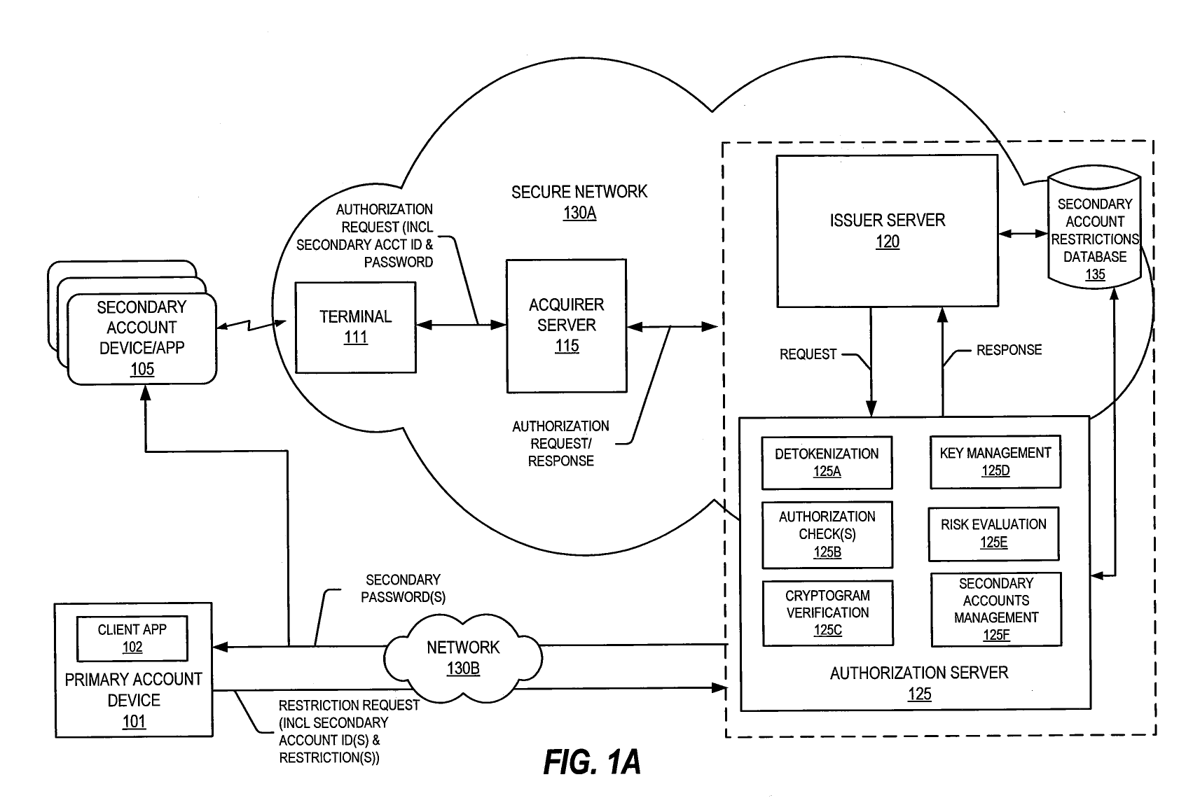

FIG. 1A is a block diagram illustrating components of a computer system or environment 100 in accordance with some embodiments. Referring now to FIG. 1A, the computer system 100 includes a merchant terminal 111, an acquirer server 115 (which may be associated with the merchant's bank), an issuer server 120 (which may be associated with the account holder's bank), an authorization server 125, and an secondary account restrictions database 135, all of which are communicatively coupled to payment nodes that define a secure payments network (referred to herein as payments network/nodes 130A). The authorization server 125 may be configured to perform various functions for the issuer server 120, including but not limited to detokenization 125A, authorization check(s) 125B, cryptogram verification 125C, key management 125D, risk evaluation 125E, and secondary accounts management 125F. In some embodiments, the authorization server 125 may be a third-party server that is communicatively coupled to the issuer server 120 and is configured to perform various functions on behalf of the issuer server 120.

At least one of the issuer server 120 and the authorization server 125 is communicatively coupled, via one or more network nodes 130B that are outside of the secure payments network 130A, to a consumer device 101 that is associated with a primary account created by the issuer server 120 (also referred to herein as a primary account device). The primary account device 101 may be any wired or wireless consumer electronic device that is configured to transmit and receive data or communications to and from the servers 120 and/or 125 outside of the secure payments network 130A. For example, the primary account device 101 may be configured to store and execute a client application 102 that is provided by the issuer server 120 and/or authorization server 125 for selection of transaction restrictions, where the client application 102 is linked or otherwise associated with the primary account. The primary account device 101 may include one or more network transceivers configured for communication with the server(s) 120/125 via the network/nodes 130B outside of the secure payments network/nodes 130A. The primary account may have one or more secondary accounts associated therewith, for example, as defined by the issuer server 120 and/or the authorization server 125. Each of the secondary accounts may be associated with a secondary account payments device 105 (such as a credit card or a mobile communications device executing a payment application). For example, the secondary account payments device 105 may be configured to store and execute a Host Card Emulation (HCE) client app that is linked or otherwise associated with one of the secondary accounts.

It will be appreciated that, in various embodiments described herein, the primary account device 101 may be a mobile phone (e.g., smart phone, cellular phone, etc.), tablet, portable media player, laptop computer, desktop computer, personal digital assistant (PDA), and/or wearable computing device (e.g., watch), or other consumer electronic device. The secondary account payments device 105 may be any device that can be transported and operated by a user to conduct a transaction with the merchant terminal 111, for example, a mobile phone, tablet, portable media player, laptop computer, personal digital assistant (PDA), wearable computing device, other consumer electronic device that is configured to execute a payments application associated with the secondary account, or a pocket-sized or other portable card (e.g., contact-based or contactless smart credit/debit card) or fob that is associated with the secondary account, and is also referred to herein as a portable payments device.

It will likewise be appreciated that, in various embodiments described herein, the issuer server 120 and authorization server 125 may be implemented as a single server, separate servers, or a network of servers (physical and/or virtual), which may be co-located in a server farm or located in different geographic regions. Various elements of the network/nodes 130B may be part of a local, wide area, or global network, such as the Internet or other publicly accessible network, which are not authorized to access (e.g., outside of) the secure payments network 130A. Various elements of the secure payments network/nodes 130A may be interconnected by a secure wide area network (WAN), local area network (LAN), Intranet, and/or other private network, which may not be accessible by the nodes of the network 130B. The networks 130A and 130B may include wireless and/or wireline networks. More generally, although FIG. 1A illustrates an example of a computing system or environment 100, it will be understood that embodiments described herein are not limited to such a specific configuration, but are intended to encompass any configuration capable of carrying out the operations described herein.

FIG. 1B is a flow diagram illustrating operations performed in requesting, generating, and receiving a secondary password that is associated with a monetary restriction for a secondary account by various components of the computer system 100 of FIG. 1A in accordance with some embodiments prior to an electronic transaction with a merchant. As shown in FIG. 1B, responsive to input from a user (e.g., the primary account holder) via its user interface, the primary account device 101 provides an identifier and password for the primary account to the issuer server 120 or the authorization server 125 (hereinafter referred to as the server 120/125) via the network/node 130B outside of the payments network 130A. The primary account device 101 also receives selection of a secondary account associated with the primary account and a monetary restriction (and/or other transaction restrictions) for the secondary account via its user interface.

In response to the selections, the primary account device 101 generates and transmits a request message containing an account identifier for the selected secondary account and the desired monetary restriction (and/or other transaction restriction parameters) for the secondary account to the server 120/125 via the network/node 130B outside of the payments network 130A. The secondary account identifier and primary account holder-defined transaction restriction(s) may be transmitted in different request messages from the primary account device 101 in some embodiments. In some embodiments, in addition to a monetary restriction, the primary account holder-defined transaction restrictions can specify transaction details including particular location(s), particular merchant(s), particular number of uses (e.g., based on an application transaction counter (ATC) to avoid replay attacks in contactless payment), duration/times of use, and/or other restrictions on the use of the secondary account.

In response to receiving the request message(s) including the secondary account identifier and monetary restriction (and/or other transaction restrictions) for the secondary account via the network/node 130B outside of the payments network 130A, the server 120/125 generates a secondary password or PIN. In some embodiments, the secondary password may be a one-time password (OTP). The secondary password is associated with the monetary restriction (and/or other primary account holder-defined transaction restrictions) for the secondary account, for example, by generating and storing a data structure indicative of the association in the secondary account restrictions database 135. The server 120/125 also marks the secondary account identifier for authentication using the generated secondary password. As described in greater detail below, responsive to generation of the secondary password, the a transaction with the primary account can be authenticated using the secondary password (rather than the primary password or PIN that is associated with the primary account) and be subjected to the secondary account restrictions associated therewith, allowing the primary account holder to maintain the primary password in confidence. In some embodiments, the secondary password may be one of multiple secondary passwords associated with the primary account, where each of the secondary passwords is generated by the server 120/125 and associated with respective primary account holder-defined transaction restriction(s) by a respective data structure stored in the database 135.

Still referring to FIG. 1B, the server 120/125 transmits a response message containing the secondary password back to the primary account device 101 (and/or other device specified by the user of the consumer device 101, such as the secondary account payments device 105) via the network/node 130B outside of the payments network 130A. In some embodiments, the response message containing the secondary password may be provided to the primary account device 101 or secondary account payments device 105 via a client application program executing thereon, rather than via SMS-based delivery (thereby avoiding delivery costs may be incurred with SMS). The primary account device 101 or secondary account payments device 105 may display the secondary password, via its user interface, for use by a secondary account holder in a subsequent transaction, which may be limited to the transaction restrictions selected by the primary account holder. For example, the secondary account may be assigned to a child, and the client application executing on the secondary account payments device 105 may allow in-app purchases to be transacted with the primary account issued to the child's parent, subject to the transaction restrictions selected by the parent. Thus, via the primary account device 101 outside of the secure payments network 130A, the primary account holder can pre-set one or more transaction restrictions for the secondary account in advance of initiation of an electronic transaction by a secondary account holder via the secondary account payments device.

In some embodiments, the primary account holder may be an employer, and the secondary account holder may be an employee. For example, a primary account holder who desires to have his driver fill his car with fuel may log into a bank application executing on the primary account device 101, and may select a “Generate One Time Card PIN” link displayed by the user interface of the primary account device 101. Responsive to selection of the link, the user interface may display a drop down menu that allows selection of the secondary account that is currently assigned to his driver, and responsive to selection of the secondary account, the user interface may display a prompt to enter the amount to which transactions with the secondary account should be limited. The primary account holder may enter a desired monetary restriction (e.g., $100), and may select the “Submit” link displayed by the user interface of the primary account device 101. In response to receiving a selection of the primary account holder-defined transaction restriction, the primary account device 101 may generate and transmit a restriction request message to the server 120/125, which may generate an OTP as a secondary password associated with the primary account holder-defined monetary restriction and transmit a restriction response message containing the OTP back to the primary account device 101. The user interface of the primary account device 101 may thus display the OTP (for example, a 6 digit number). The primary account holder can share the OTP with his driver, which can be used by the driver (as a secondary account holder) to authenticate a transaction between the POS and the primary account, where the transaction is limited to the monetary restriction (e.g., $100) for the secondary account.

In further embodiments, the primary account holder may be parent or household provider, and the secondary account holder may be a child or other dependent. For example, a primary account holder who desires to pay college expenses for his child may log into a bank application executing on the primary account device 101, and may select a “Generate One Time Card PIN” link displayed by the user interface of the primary account device 101. Responsive to selection of the link, the user interface may display a drop down menu that allows selection of the secondary account that is currently assigned to the child, and responsive to selection of the secondary account, the user interface may display a prompt to enter the amount to which transactions with the secondary account should be limited. The primary account holder may enter a desired monetary restriction (e.g., $500), and may select the “Submit” link displayed by the user interface of the primary account device 101. In response to receiving a selection of the primary account holder-defined transaction restriction, the primary account device 101 may generate and transmit a restriction request message to the server 120/125, which may generate an OTP as a secondary password associated with the primary account holder-defined monetary restriction and transmit a restriction response message containing the OTP back to the primary account device 101. The user interface of the primary account device 101 may thus display the OTP (for example, a 6 digit number). The primary account holder can share the OTP with his child, who may be at a college away from home. The OTP can be used by the child (as a secondary account holder) to authenticate a transaction with the primary account, for example at an ATM, where the ATM transaction is limited to the monetary restriction (e.g., $500) for the secondary account. Thus, the child can withdraw $500 from the primary account using a secondary account payments device (e.g., an ATM card) at the ATM by entering the OTP for authentication.

FIG. 1C is a flow diagram illustrating operations performed by the secondary account payments device 105 initiating and conducting an electronic transaction between the merchant terminal 111 and the primary account using the secondary password generated in FIG. 1B by various components of the computer network of FIG. 1A in accordance with some embodiments. As shown in FIG. 1C, in initiating an electronic transaction, a secondary account holder provides, via the secondary account payments device 105, a secondary account identifier (for example, a secondary account card number) associated with the secondary account to a merchant terminal 111. For instance, the secondary account payments device 105 may be a ‘smart’ or EMV-compliant credit/debit card including an integrated circuit chip therein, which provides the secondary account identifier to the merchant terminal 111 via a contact-based or contactless payment method (for example, by including the secondary account card number in a message transmitted via radio-frequency identification or near field communication). Alternatively, the secondary account payments device 105 may be a mobile device executing a client payments application, which wirelessly transmits a message containing the secondary account identifier to the merchant terminal 111. The secondary account holder also provides the OTP associated with the primary account holder-defined transaction parameter(s), which was generated as a secondary password in FIG. 1B, to the merchant terminal 111. For instance, in some embodiments, the secondary account holder may physically enter the OTP on a keypad or other user interface associated with the merchant terminal 111. Additionally or alternatively, the OTP may be included in a message (for example, in a transaction cryptogram) that is wirelessly transmitted from the secondary account payments device 105 to the merchant terminal 111. The transaction cryptogram may be generated by the secondary account payments device 105 based on transaction details received from or otherwise specified by the merchant terminal.

In response, the merchant terminal 111 generates a transaction authorization request message including the OTP and the secondary account identifier, and transmits the authorization request message to the server 120/125 via the secure payments network/node 130A. The transaction authorization request message transmitted by the merchant terminal 111 may include other transaction data (for example, the transaction cryptogram that was generated by the secondary account payments device 105). In response to receiving the transaction authorization request message, the server 120/125 verifies the secondary account identifier, identifies the secondary account as being associated with the primary account, performs authentication based on the OTP for the secondary account (rather than based on a primary password that is associated with the corresponding account), and identifies the primary account holder-defined monetary restriction (and/or other transaction restrictions) that are associated with the OTP.

Still referring to FIG. 1C, the server 120/125 generates an authorization response message for an electronic transaction between the primary account and the merchant terminal by applying the identified monetary restriction(s) for the secondary account to the transaction with the primary account, and transmits the authorization response toward the merchant terminal 111 via the secure payments network/node 130A. For example, the authorization response message may indicate authorization for the electronic transaction for up to the monetary restriction that was previously-defined by the primary account device 101 and associated with the OTP for the secondary account by the server 120/125 in the operations of FIG. 1B. Alternatively, the authorization response message may indicate denial of the electronic transaction, for instance, where the merchant terminal 111 specifies a transaction amount that exceeds the primary account holder-defined monetary restriction associated with the OTP for the secondary account. The merchant terminal 111 thereby indicates acceptance or declination of the electronic transaction to the secondary account holder using the secondary account payments device 105 (for example, via the merchant terminal's user interface or by transmitting a message to the secondary account payments device 105 for display thereby). As such, control over the transaction details, and in particular the maximum monetary amount for the electronic transaction with the primary account, can be controlled by the primary account holder, for one or more secondary account holders.

For instance, in the employer/employee example discussed above, the secondary account payments device 105 may be credit/debit card associated with the secondary account, and the merchant terminal 111 may be a merchant POS. At the time of the transaction, the driver may hand the card 105 to the merchant, who may swipe the card 105 at the POS 111 to input the secondary account identifier. The driver may also physically enter the OTP (received via the network 130B) via a user interface of the POS 111. In response to receiving the OTP, the POS 111 may generate and transmit an authorization request message including the OTP and the secondary account identifier via the secure payments network/node 130A to a server 120/125, which may identify that the secondary account is associated with a primary account, perform authentication using the OTP (rather than the primary account password), identify that the OTP is associated with a primary account holder-defined monetary restriction (e.g., $100 in the example of FIG. 1B), charge or debit the primary account for a transaction amount that does not exceed the monetary restriction for the secondary account, and generate and transmit an authorization response message indicative of the same toward the POS 111 via the secure payments network/node 130A. The POS 111 may provide an indication of success or failure of the electronic transaction to the driver, for example, via the user interface of the POS 111.

Likewise, in the parent/child example discussed above, the merchant terminal 111 may be an ATM, and the secondary account payments device 105 may be bank/ATM card associated with the secondary account. At the ATM 111, the child may insert the card 105 into the ATM 111 to input the secondary account identifier, and the ATM 111 may display a prompt asking the child to enter the PIN associated with the card 105. The child may enter the OTP that was previously provided via a network node 130B that is outside of the secure payments network 130A, and the ATM 111 may generate and transmit an authorization request message including the OTP and the secondary account identifier to a server 120/125 via the secure payments network/node 130A. The server 120/125 may be associated with the issuer of the primary account, or may be an authorization server that is coupled to the issuer via the secure payments network 130A. The server 120/125 may identify that the secondary account is associated with a primary account, perform authentication using the OTP (rather than the primary account password), identify that the OTP is associated with a primary account holder-defined monetary restriction (e.g., $500), charge or debit the primary account for a transaction amount that does not exceed the monetary restriction for the secondary account, and generate and transmit an authorization response message indicative of the same toward the ATM 111 via the secure payments network/node 130A. The ATM 111 may then output the amount requested by the secondary account holder, not to exceed the primary account holder-defined monetary restriction (e.g., $500).

Although discussed above in FIGS. 1B and 1C with reference to an OTP as a secondary password by way of example, it will be understood that generation of the OTP is but one method by which the secondary account payments device 105 can by authenticated during a transaction. As such, embodiments described herein are not limited to authentication based on one-time passwords, and other secondary passwords (for example, a static PIN for each secondary account) and/or other methods may be used for authentication and authorization of the secondary account device for use of the primary account. Also, in some embodiments, the secondary password-based authentication for a transaction may only be possible responsive to receiving specification of the secondary account restrictions from the primary account holder; otherwise the authentication may fail and the transaction may be declined.

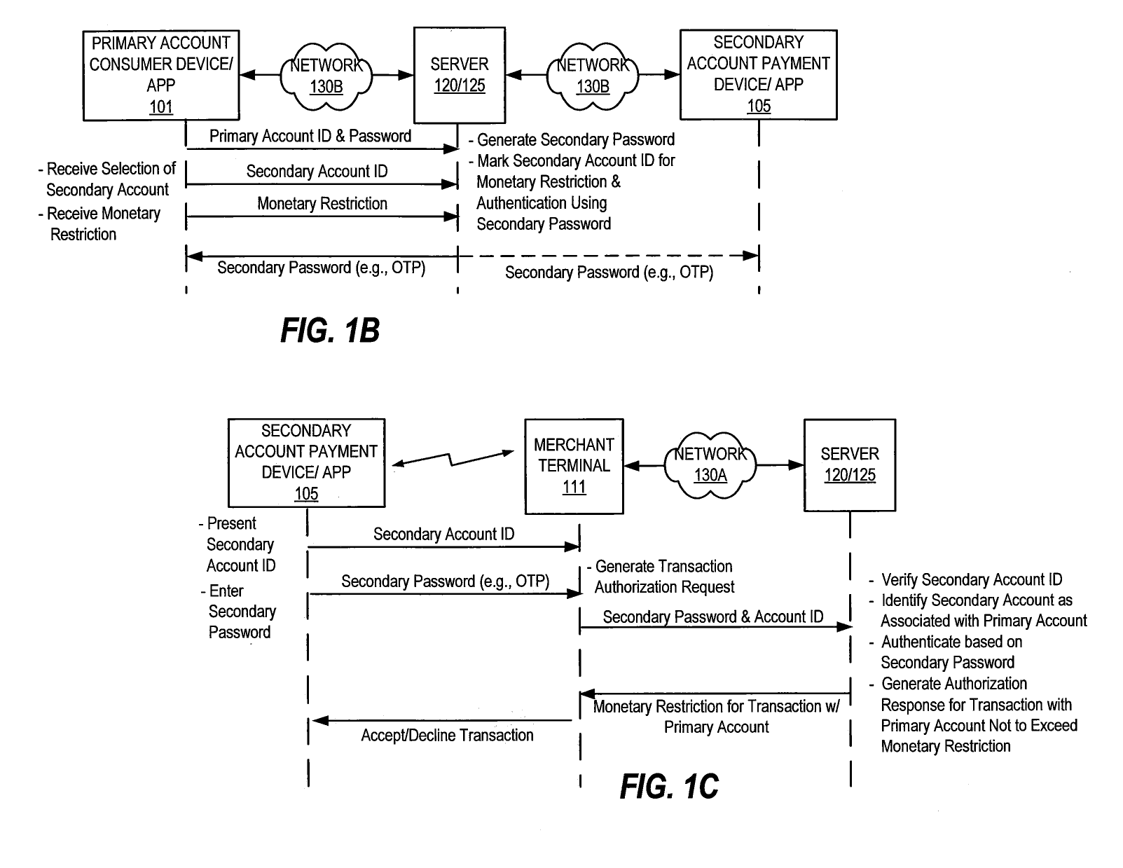

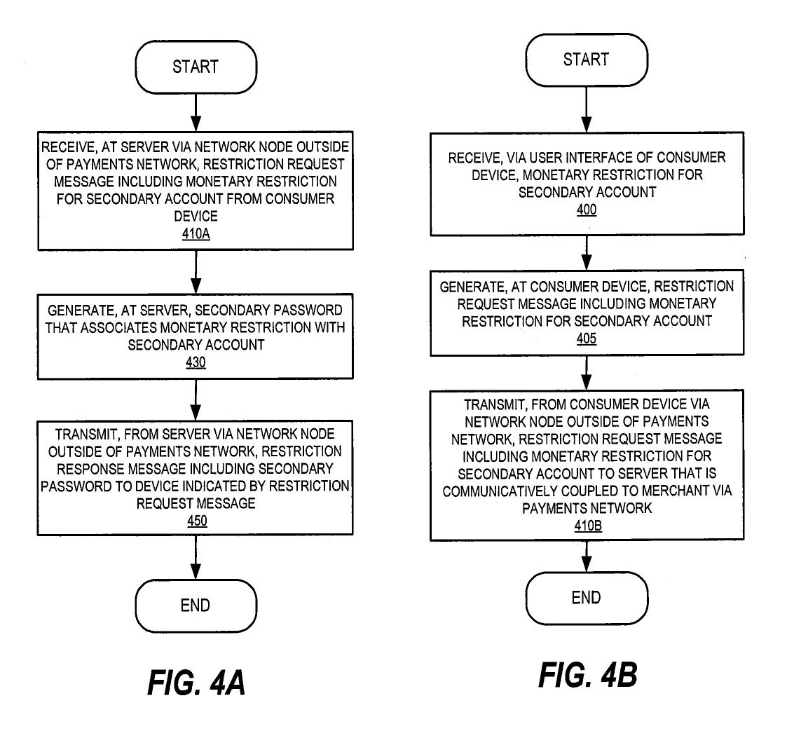

FIGS. 2-5 are flowcharts illustrating operations performed by various components of a computer system in accordance with some embodiments. For example, the operations of FIGS. 2, 3, 4A, 5, and 6 may be performed by a computer server communicatively coupled to a payment node of a secure payments network (for example, the authorization server 125 and/or the issuer server 120 of FIG. 1A), while the operations of FIG. 4B may be performed by a consumer device that is not communicatively coupled to one of the payment nodes of a secure payments network (for example, the primary account device 101 and/or the secondary account payments device 105 of FIG. 1A). Referring to FIG. 2, at block 200, a restriction request message including a monetary restriction for a secondary account is received from a consumer device associated with a primary account at a computer server. The restriction request message may further include additional restrictions for the secondary account (also referred to herein as transaction restriction parameters), for example, particular geographic locations, particular merchants, particular durations/times of use, and/or particular number of uses. The consumer device may be associated with the primary account by logging into to a web portal and/or executing a client application that communicatively couples the consumer device to the computer server that maintains the primary account. The server is coupled to a payment node of a secure payments network, while the restriction request message is received from the consumer device via a network node that is outside of the payments network.

In response to receiving a subsequent authorization request for a transaction with the secondary account via a merchant terminal that is coupled to one of the payment nodes of the secure payments network, the monetary restriction for the secondary account (and/or other secondary account transaction restriction parameters) is applied to the primary account, and an authorization response message for an electronic transaction between the merchant terminal and the primary account is transmitted from the server via the payments network at block 240. The authorization response message may indicate authorization for the transaction between the primary account and the merchant terminal, based on the monetary restriction specified for the secondary account, which was received at block 200. That is, the authorization response message is generated and transmitted to control a transaction with the primary account within the nodes of the payments network, based on one or more transaction restriction parameters received via a network node that is outside of the payments network.

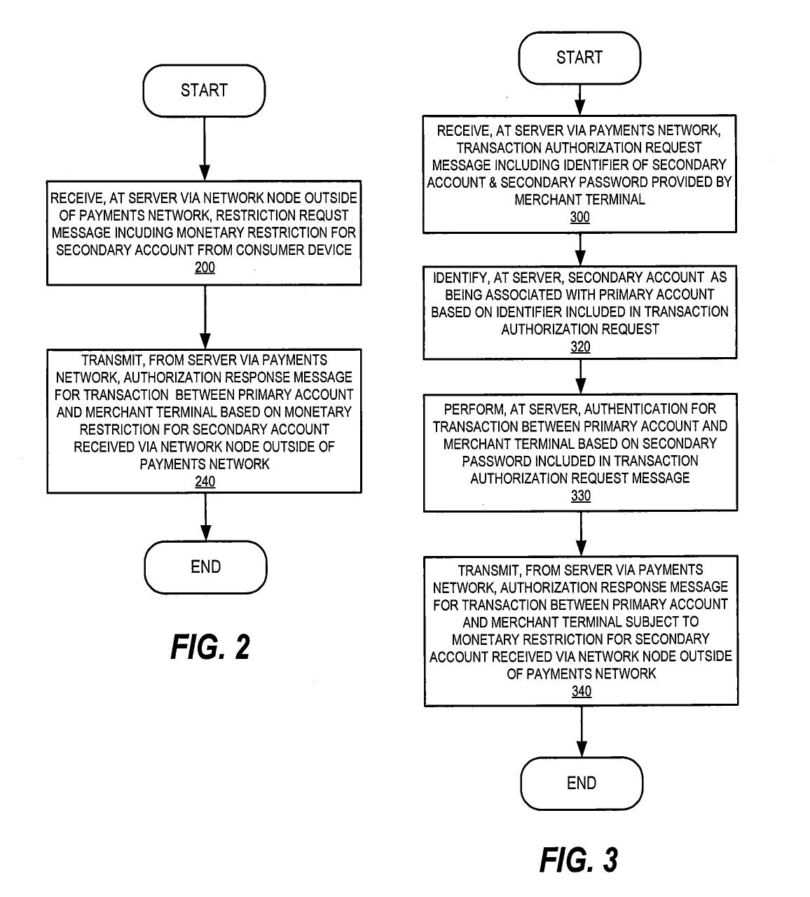

FIG. 3 is a flowchart illustrating further operations that may be performed by a computer server coupled to a payment node of the secure payments network, such as the authorization server 125 and/or the issuer server 120 of FIG. 1A, according to some embodiments. Referring now to FIG. 3, at block 300, a transaction authorization request message for an electronic transaction with a merchant terminal is received at a computer server via a payments node of the payments network to which the merchant terminal is communicatively coupled. The transaction authorization request message includes an identifier of a secondary account and an associated secondary password, which are provided by the merchant terminal, for example, in a transaction cryptogram. At block 320, the secondary account is identified as being associated with a primary account based on the identifier included in the transaction authorization request message. For example, the secondary account identifier may be recognized as a token that was previously generated by the server to associate the secondary account as a sub-account of the primary account, as described in greater detail below.

Responsive to identification of the secondary account as being associated with the primary account, authentication for a transaction between the primary account and the merchant terminal is performed based on the secondary password at block 330. That is, the secondary password for the secondary account is used for authentication of a transaction with the primary account, independent of receiving the primary password (which is specified for authentication of the primary account) via the payments network. In some embodiments, authentication based on the secondary password may be performed only responsive to receiving a restriction request message specifying one or more transaction restrictions for the secondary account (or other action by the primary account holder); else authentication based on the secondary password may fail. At block 340, an authorization response message for the transaction between the merchant terminal and the primary account, subject to the monetary restriction (and/or other transaction restriction(s)) for the secondary account, is generated by the server and transmitted toward the merchant terminal via a network node of the payments network. The monetary restriction (and/or other transaction restriction(s)) may have been previously received at the server via network node outside of the payments network, for example, from a consumer device associated with the primary account as described with reference to block 200 of FIG. 2, and the authorization response message may be generated by the server at block 340 responsive to accessing a previously-stored data structure that logically associates the transaction restriction(s) with the secondary account.

FIG. 4A is a flowchart illustrating operations for generation of a secondary password and association of the secondary password with one or more transaction restrictions for the secondary account, which may be performed by a computer server coupled to a payments node of the payments network (for example, by the authorization server 125 and/or the issuer server 120 of FIG. 1A) according to some embodiments. Referring now to FIG. 4A, at block 410A, a restriction request message including a monetary restriction for a secondary account is received at the server from a consumer device, via a network node that is outside of the payments network. The consumer device may be a wired or wireless communications terminal, which may be executing a web-based or client application program for communication with an issuer of the primary account, either directly (via an issuer-owned server) or indirectly (via a third-party authorization server). In response to receiving the restriction request message from the consumer device, a secondary password is generated by the server at block 430. The secondary password may be generated such that it is associated with the monetary restriction included in the restriction request message, for example, by creation and storage of a corresponding data structure in a database that is accessible to the server, such as the secondary account restrictions database 135 of FIG. 1A.

Still referring to FIG. 4A, at block 450, a restriction response message including the secondary password is generated by and transmitted from the server to a device indicated by the restriction request message or otherwise specified by the consumer device, via a network node that is outside of the payments network. For example, the server may transmit the secondary password to the consumer device associated with the primary account (from which the restriction request message was received, such as the primary account device 101 of FIG. 1A), or to a device associated with the secondary account (for which the monetary restriction is specified, such as the secondary account payments device 105). While primarily described in FIG. 4A with reference to generating a secondary password that is associated with a monetary restriction for the secondary account, it will be understood that the monetary restriction may be one of multiple secondary account transaction restrictions included in the restriction request message, and that the secondary password may be generated such that is associated with such multiple transaction restrictions for the secondary account. Also, it will be understood that the secondary account may be one of multiple secondary accounts that is associated with the primary account, each of which may be associated with respective monetary and/or other transaction restrictions, for example, by respective data structures stored in a database that is accessible to the server.

FIG. 4B is a flowchart illustrating operations that may be performed by a consumer device (such as the primary account device 101 and/or the secondary account payments device 105 of FIG. 1A) to initiate association of one or more transaction restrictions with a secondary account according to some embodiments. Referring now to FIG. 4B, a monetary restriction for a secondary account is received via a user interface of the consumer device at block 400. In some embodiments, a user of the consumer device (for example, a primary account holder) may login to a web portal linked to the issuer using an identifier and password corresponding to the primary account, may select the secondary account by providing an account identification number or other account identifier corresponding to the secondary account, and may enter a desired monetary restriction to which transactions initiated by the secondary account/secondary account holder are to be limited. In other embodiments, the user of the consumer device may download a client application (or “app”) that is configured for communication with the issuer and is associated with the primary account, and may select the secondary account and the desired monetary restriction via the app. In some embodiments, the user may also specify additional transaction restrictions (for example, particular geographic locations, particular merchants, particular number of uses, and/or particular durations/times of use) via the user interface of the consumer device.

In response to the input received via the user interface at block 400, a restriction request message including the monetary restriction (and/or other transaction restrictions) for the secondary account is generated at the consumer device at block 405. At block 410B, the restriction request message is transmitted from the consumer device to a computer server that is communicatively coupled to a payment node of a payments network, such as the server 120/125. However, as the consumer device lacks access to the secure payments network, the restriction request message is transmitted to the server at block 410B via a network node that is outside of the payments network. As such, a primary account holder may exercise control over an electronic transaction that is initiated by a secondary account holder and is conducted via the payments network, using a consumer device that is not configured to access the payments network.

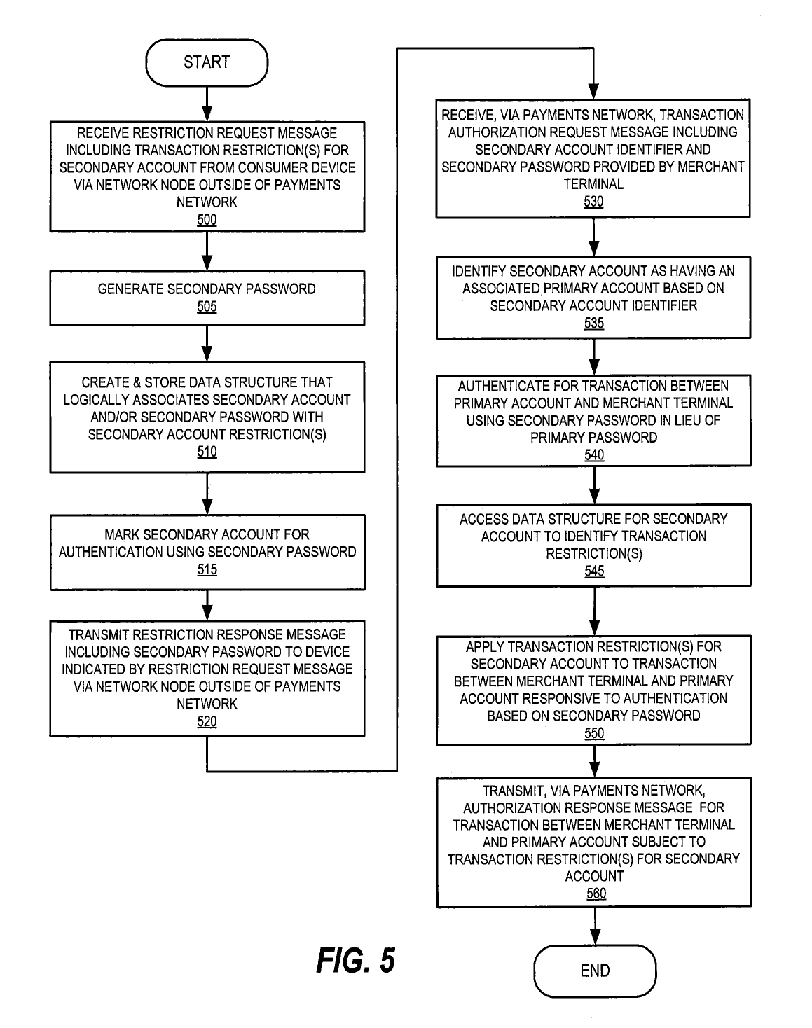

FIG. 5 is a flowchart illustrating operations that may be performed by a computer server (such as the authorization server 125 and/or the issuer server 120 of FIG. 1A) in authenticating and authorizing a transaction initiated by a secondary account holder in accordance with some embodiments described herein. Referring now to FIG. 5, a restriction request message including one or more transaction restriction parameters for a secondary account is received from a consumer device at block 500. The transaction restriction parameters may include, but are not limited to, a monetary restriction, a restriction to particular merchants or merchants, a restriction to particular geographic location or locations, a restriction with respect to a limited number of uses, and/or a restriction with respect to a particular duration/time of use of the secondary account. The restriction request message may be transmitted from the consumer device responsive to input by a primary account holder and responsive to authentication based on an identifier and password associated with the primary account. The restriction request message is received from the consumer device via a network that is outside of (e.g., unauthorized for communication with) a secure payments network.

In response to receiving the restriction request message, a secondary password is generated at block 505, and a data structure that logically associates the secondary account and/or the secondary password with the transaction restriction parameter(s) for the secondary account is created and stored in a database that is accessible to the server at block 510. The secondary password may be a static password or PIN, or may be a one-time password or PIN (OTP) in some embodiments. In addition, in response to the authentication based on the identifier and password associated with the primary account, the secondary account is marked for authentication using the secondary password at block 515. As described in detail below, as the secondary account is a sub-account of the primary account, the secondary password may be used for authentication of a transaction with the primary account (subject to the transaction restrictions for the secondary account) responsive to the marking of the secondary account for authentication using the secondary password at block 515. A restriction response message including the secondary password is thus generated and transmitted to a device indicated by the restriction request message at block 520. For instance, the restriction request message may specify that the secondary password is to be sent to the consumer device from which the restriction request message was received at block 500, and/or to a payments device associated with the secondary account. The restriction response message is transmitted to the specified device via a network node outside of the payments network at block 520. However, the restriction response message including the secondary password may also be sent to one of the payment nodes within the payment network and/or to an electronic device associated therewith. In either example, by transmitting the secondary password to another device at block 520, the primary account holder may avoid disclosing the primary password for the primary account to the secondary account holder and/or to a merchant with whom the secondary account holder desires to transact.

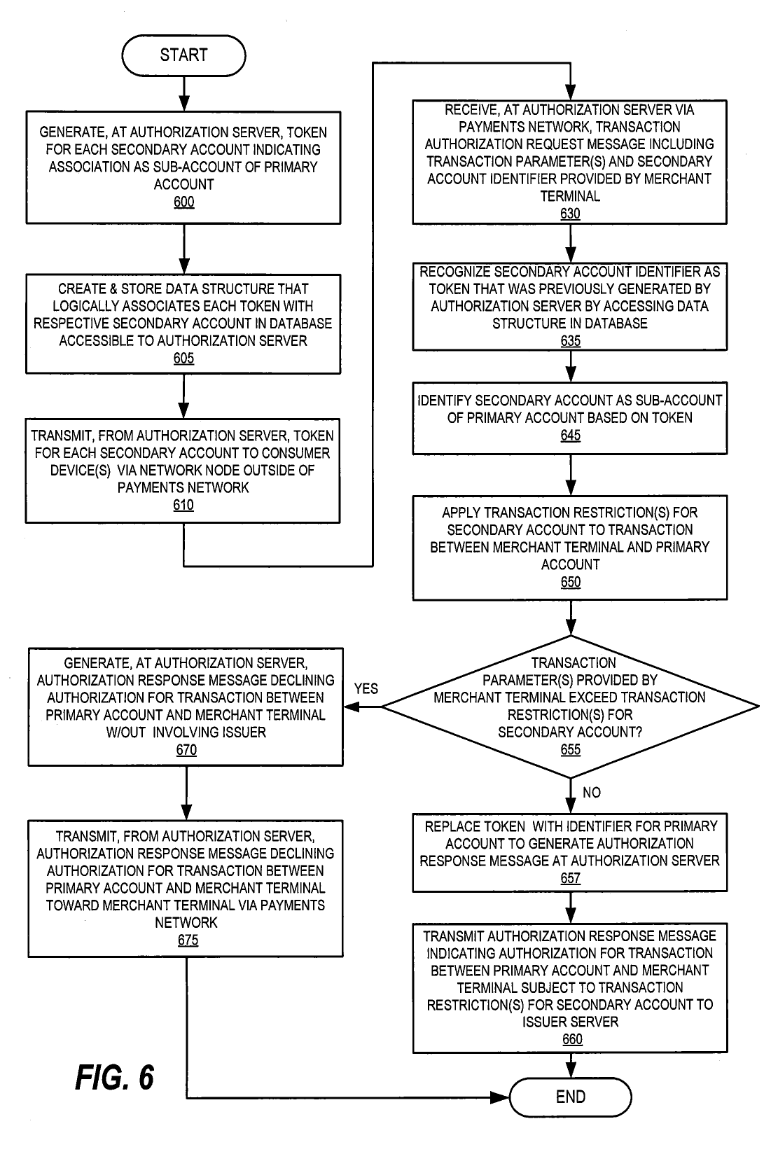

Subsequent to the operations of blocks 500-520, a transaction authorization request message including the secondary account identifier and the secondary password is received via a network node of the payments network at block 530. For instance, the secondary account identifier and the secondary password may be included in the authorization request message responsive to receipt thereof (directly or indirectly) from a merchant terminal that is communicatively coupled to one of the payment nodes of the payments network. Based on the secondary account identifier contained in the transaction authorization request message, the secondary account is verified and identified as being associated with a primary account at block 535, for instance, upon recognition of the secondary account identifier as a token that was previously generated by the server to associate the secondary account as a sub-account of the primary account, as described in greater detail below with reference to FIG. 6.

Responsive to identifying the secondary account as being associated with the primary account, a transaction between the primary account and a merchant terminal is authenticated using the secondary password instead of the primary password at block 540. As the secondary account was previously marked for authentication based on the secondary password at block 515, and as the secondary account was identified as being associated with the primary account at block 535, the authentication for the transaction may be performed at block 540 based solely on the secondary password, that is, without or independent of receiving the primary password for the primary account via the payments network. Responsive to the authentication based on the secondary password, the data structure (which was created at block 510) is accessed to identify the transaction restriction parameter(s) associated with the secondary account at block 545, and the transaction restriction parameter(s) for the secondary account are applied to the transaction between the merchant terminal and the primary account at block 550.

Still referring to FIG. 5, an authorization response message for the transaction between the merchant terminal and the primary account, subject to the transaction restriction parameter(s) for the secondary account, is thus generated and transmitted towards the merchant terminal via a node of the payments network at block 560. For instance, the authorization response message may indicate authorization for the transaction between the merchant terminal and the primary account, provided that the transaction parameters received from the merchant terminal do not exceed or otherwise do not conflict with the transaction restriction parameter(s) identified for the secondary account at block 545 and applied to the primary account at block 550. Otherwise, the authorization response message may deny or decline authorization for the transaction between the merchant terminal and the primary account.

While described above with reference to operations that may be generally performed by an issuer server 120 and/or an authorization server 125, in some embodiments described herein the authorization server 125 is configured to perform operations such that the existence and/or use of the secondary account(s) is transparent to the issuer. In particular, FIG. 6 is a flowchart illustrating operations that may be performed by a computer server (such as the authorization server 125 of FIG. 1A) that is coupled between the merchant and the issuer, in authenticating and authorizing a transaction initiated by a secondary account holder for secondary account (which is not directly managed by the issuer of the primary account) in accordance with some embodiments described herein.

Referring now to FIG. 6, responsive to a request from a primary account holder to create one or more secondary accounts linked as one or more sub-accounts of a primary account, a token is generated for each secondary account by the authorization server at block 600. Each token may be a numerical or other identifier corresponding to one of the secondary accounts. At block 605, one or more data structures that logically associate each token with its respective secondary account are created and stored in a database that is accessible to the authorization server. For example, a data structure may be created for each primary account, listing one or more secondary accounts that are sub-accounts of the primary account, and listing the token or other identifier generated for each of the secondary accounts. For instance, in some embodiments, the authorization server may create and maintain a list of secondary credit/debit card numbers and corresponding tokens that are assigned to a same primary credit/debit card number. The token for each secondary account is transmitted from the authorization server to at least one consumer electronic device via a network node that is outside of the payments network at block 610. For example, a message including one of the tokens may be transmitted to a payments device that is associated with the corresponding secondary account, for use in subsequent transactions thereby.

Subsequent to the operations of blocks 600-610, a transaction authorization request message including a secondary account identifier and one or more transaction parameters provided by a merchant terminal is received at the authorization server via the payments network at block 630. The secondary account identifier and/or other data in the transaction authorization request message may include a resource locator identifying the authorization server, such that the transaction authorization request message is routed to the authorization server via the payments network. In some embodiments, the authorization request message may be transmitted to the authorization server by the issuer server, while in other embodiments, the authorization request message may be transmitted to the authorization server by one or more other network node(s) of the payments network, such that the authorization server may receive the transaction authorization request message prior to or independent of the issuer server.

Responsive to receiving the transaction authorization request message at the authorization server, the secondary account identifier included therein is identified or otherwise recognized as a token that was previously generated by the authorization server at block 635. In particular, the secondary account identifier may be recognized by accessing the data structure that was created and stored in the database at block 605. At block 645, the secondary account is identified as a sub-account of the primary account responsive to recognition of the token, and one or more transaction restrictions for the secondary account are determined and applied to a transaction between the merchant terminal and the primary account at block 650 responsive to identification of the secondary account as a sub-account of the primary account. For example, as discussed above with reference to FIG. 5, authentication may be performed based on a secondary password included in the transaction authorization request message, and a data structure stored in a database that is accessible to the authentication server (such as the secondary account restrictions database 135 of FIG. 1A) may be accessed to determine the transaction restrictions for the secondary account, where the data structure logically associates the transaction restrictions with the secondary account responsive to a restriction request message from the primary account holder.

Still referring to FIG. 6, at block 655, it is determined whether the transaction parameters specified by the merchant terminal (as indicated in the transaction authorization request message at block 630) exceed the transaction restriction(s) for the secondary account (as determined at block 650). If so, an authorization response message declining authorization for the transaction between the primary account and the merchant terminal is generated by the authorization server at block 670. As management of the secondary account may be handled by the authorization server in a manner that is transparent to the issuer in the embodiment of FIG. 6, the authorization server may generate the authorization response message declining authorization for the transaction at block 670 without involving the issuer server. That is, in some embodiments, transmission of the authorization response message to the issuer server may be prevented responsive to determining, at block 655, that the monetary amount for the transaction (or other transaction parameter(s)) specified by the merchant terminal exceeds the monetary restriction (or other transaction restriction(s)) for the secondary account. As such, at block 675, the authorization response message declining authorization for the transaction between the primary account and a merchant terminal is transmitted from the authorization server toward the merchant terminal via the payments network.

On the other hand, if it is determined at block 655 that the transaction parameter(s) specified by the merchant terminal do not exceed the transaction restriction(s) for the secondary account, an authorization response message indicating authorization for the transaction between the primary account and the merchant terminal is generated by the authorization server at block 657. In particular, in generating the authorization response message, the token in the transaction authorization request message, as recognized at block 635, is replaced with an identifier for the primary account. The identifier of the primary account may be identical to that issued by or otherwise known to the issuer of the primary account. As such, at block 660, the authorization response message indicating authorization for the transaction between the primary account and the merchant terminal (subject to the transaction restrictions for the secondary account) is transmitted to the issuer server. That is, in some embodiments, the authorization response message may only be transmitted to or otherwise involve the issuer server responsive to determining, at block 655, that the monetary amount for the transaction (or other transaction parameter(s)) specified by the merchant terminal does not exceed the monetary restriction (or other transaction restriction(s)) for the secondary account.

Upon receipt of the authorization response message authorizing the transaction between the primary account and the merchant terminal, the issuer server may charge or debit the primary account for the monetary amount specified by the merchant terminal, and may transmit a response message indicative of the same toward the merchant terminal, either directly or via the authorization server. As such, the issuer server may approve the transaction between the primary account and the merchant terminal without knowledge that the secondary account was used to initiate the transaction. That is, the issuer server may approve the transaction between the primary account and the merchant terminal independent of (from the perspective of the issuer) whether the transaction was initiated by the primary account holder/device or the secondary account holder/device.

In the operations of FIG. 6, the issuer may thus be unaware of the use of the secondary account(s) (and/or the monetary or other transaction restrictions associated therewith) in approving or declining transactions with the primary account. In some embodiments, even the existence of the secondary account(s), the associated secondary account identifier(s), and/or the associated transaction restriction(s) may be unknown to the issuer. For example, the authorization server may create the secondary account(s) as sub-accounts of the primary account, generate the account identifier(s)/token(s) for the secondary account(s), and associate the secondary account(s) with the received transaction restriction(s) independent of the issuer. Alternatively, in some embodiments, the authorization server may handle management of the secondary account(s) on behalf of and responsive to approval by the issuer server, which may act as an intermediary in forwarding the transaction authorization request and response messages between the authorization server and the merchant terminal. In yet other embodiments, a single server may perform the operations discussed above with reference to the separate issuer and authorization servers.

Embodiments described herein may provide several advantages. For example, embodiments described herein may provide enhanced security in allowing a secondary account holder to use a primary account to conduct transactions with a merchant, as the amount that can be withdrawn from/charged to the primary account is limited to the restrictions previously-set for the secondary account, and the primary account can be charged/debited without communicating or otherwise sharing the primary password or PIN with the secondary account holder and/or merchant. In addition, embodiments described herein may allow use of the primary account by multiple secondary account holders, each limited to respective monetary amounts and/or other transaction restrictions based on respective secondary passwords. Also, the secondary account or accounts may only be used with the corresponding secondary password, and in embodiments where an OTP is used as a secondary password, each OTP is valid for one use only. Thus, a merchant with whom the secondary account number and OTP is shared cannot make subsequent withdrawals from the primary account, as the primary password/PIN is not shared with the merchant, and the OTP is valid only once. Moreover, embodiments described herein may offer the above benefits without inconvenience to the primary account holder, as the primary card and associated primary account can be used without restriction. Thus, embodiments described herein may be used in open-loop payment systems, while still providing restrictions on account use that are typically associated with closed-loop payment systems. Embodiments described herein can be used in a mobile device that supports payment by means of NFC, BLE, QR code, and/or other methods of payment.

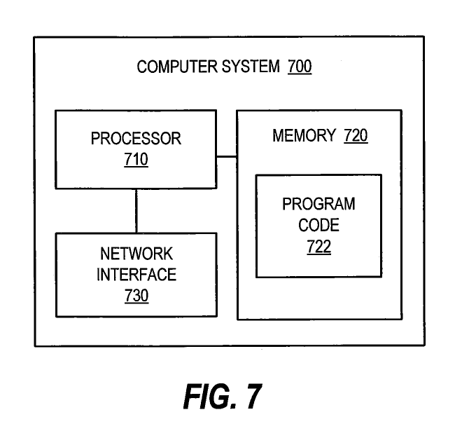

FIG. 7 is a block diagram of a computer system 700 that may be used as an authorization server/node 125, issuer server/node 120, primary account device 101, secondary account payments device 105, merchant terminal/node 111, and/or other computer hardware to perform the operations of one of more of the embodiments disclosed herein for one or more of those elements. The computer system 700 can include one or more network interface circuits 730, one or more processor circuits 710 (referred to as “processor” for brevity), and one or more memory circuits 720 (referred to as “memory” for brevity) containing computer-readable program code 722.

The processor 710 may include one or more data processing circuits, such as a general purpose and/or special purpose processor (e.g., microprocessor and/or digital signal processor) that may be collocated or distributed across one or more networks. The processor 710 is configured to execute program code 722 in the memory 720, described below as a computer readable storage medium, to perform some or all of the operations for one or more of the embodiments disclosed herein.

When the computer system 700 is configured as a primary account device 101 or secondary account payments device 105, the network interface 730 includes one or more radio transceivers configured to communicate with wireless devices (such as merchant terminal 111) using one or more radio access technologies. The radio access technologies may include, but are not limited to, Near Field Communication (NFC), Bluetooth, WLAN (IEEE 802.11), 3GPP Long Term Evolution (LTE), etc.

When configured as a primary account device 101 or secondary account payments device 105, the computer system 700 described herein may be provisioned with account parameters (including the transaction restrictions described herein) to enable the devices to conduct transactions with respect to the primary and/or secondary account. Account parameters (also referred to as “account credentials”) are information relating to an account (e.g., a financial account, bank account, payment account, etc.) associated with a user that can be used to conduct transactions on the user's account (e.g., by placing the device in proximity to a contactless reader of an access device such as a point-of-sale (POS) terminal). Account parameters may include a semi-static set of data and a dynamic set of data, and some of the account parameters may be limited-use account parameters. The semi-static set of data may include an identifier that can be used to identify the account associated with the device (e.g., an account identifier such as a primary account number (PAN), an alternate account identifier such as a secondary PAN, or a token that is a substitute for an account identifier, etc.), an expiry date, and/or other account details or data that does not necessarily change for an extended period of time, or in some embodiments, for the lifetime of the account. The dynamic set of data may include one or more keys, information associated with the one or more keys, and/or other dynamic data that has a limited lifespan and is repeatedly refreshed or replenished during the lifetime of an account. The dynamic set of data can be used for or can relate to on-device generation of dynamic transaction cryptograms, or can represent dynamic transaction data during payment transactions. The dynamic set of data may be limited-use in the sense that the dynamic set of data can be used for only a limited time or a limited number of transactions, and may need to be renewed, refreshed, updated, or replenished when the dynamic set of data has exhausted its limited usage. For example, the dynamic set of data may include a limited-use key (LUK) that is used as an encryption key to generate a transaction cryptogram during a transaction.

### FURTHER DEFINITIONS AND EMBODIMENTS

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A computer server, comprising:
a network interface;
a processor coupled to the network interface; and
a memory coupled to the processor, the memory comprising a computer-readable storage medium storing computer-readable program code therein that, when executed by the processor, causes the processor to perform operations comprising:
receiving, through the network interface via a network node that is outside of a secure authorization network comprising a plurality of nodes, a restriction request message comprising a restriction for a secondary account from a user device;
receiving, through the network interface via the secure authorization network, an authorization request message comprising an identifier of the secondary account and a secondary password provided by a terminal that is communicatively coupled to one of the nodes;
identifying the secondary account as being associated with a primary account based on the identifier included in the authorization request message;
performing authentication for an electronic transaction between the terminal and the primary account based on the secondary password responsive to the identifying; and
selectively transmitting, through the network interface via the secure authorization network, an authorization response message for the electronic transaction between the terminal and the primary account based on the restriction for the secondary account responsive to the authentication based on the secondary password.

2. The computer server of claim 1, wherein the secure authorization network comprises a payments network, the restriction comprises a monetary restriction, the terminal comprises a merchant terminal, and the user device comprises a consumer device, and wherein the authentication for the electronic transaction between the merchant terminal and the primary account is performed by the computer server based on the secondary password and independent of a primary password associated with the primary account.

3. The computer server of claim 2, wherein, responsive to the identifying the secondary account as being associated with the primary account and prior to the transmitting the authorization response message, the computer-readable program code, when executed by the processor, causes the processor to perform operations comprising:
accessing a data structure stored in a database that is accessible to the computer server to determine the monetary restriction for the secondary account, which was received from the consumer device via the network node that is outside of the payments network; and
generating the authorization response message by applying the monetary restriction for the secondary account to the electronic transaction between the merchant terminal and the primary account.

4. The computer server of claim 2, wherein, in the identifying the secondary account, the computer-readable program code, when executed by the processor, causes the processor to perform operations comprising:
identifying the identifier of the secondary account included in the authorization request message as a token that was previously generated by the computer server, wherein the token associates the secondary account as a sub-account of the primary account.

5. A method, comprising:
performing operations as follows by a processor of a computer server that is communicatively coupled to one of a plurality of payment nodes of a payments network:
receiving, by the computer server via a network node that is outside of the payments network, a restriction request message comprising a monetary restriction for a secondary account from a consumer device;
receiving, by the computer server via the payments network, a transaction authorization request message comprising an identifier of the secondary account and a secondary password provided by a merchant terminal that is communicatively coupled to one of the payment nodes;
identifying, by the computer server, the secondary account as being associated with a primary account based on the identifier included in the transaction authorization request message;
performing, by the computer server, authentication for an electronic transaction between the merchant terminal and the primary account based on the secondary password responsive to the identifying; and
selectively transmitting, from the computer server via the payments network, an authorization response message for the electronic transaction between the merchant terminal and the primary account based on the monetary restriction for the secondary account responsive to the authentication based on the secondary password.

6. The method of claim 5, wherein the authentication for the electronic transaction between the merchant terminal and the primary account is performed by the computer server based on the secondary password and independent of a primary password associated with the primary account.

7. The method of claim 6, further comprising the following responsive to the identifying the secondary account as being associated with the primary account and prior to transmitting the authorization response message:
accessing a data structure stored in a database that is accessible to the computer server to determine the monetary restriction for the secondary account, which was received from the consumer device via the network node that is outside of the payments network; and
generating the authorization response message by applying the monetary restriction for the secondary account to the electronic transaction between the merchant terminal and the primary account.

8. The method of claim 7, further comprising the following prior to receiving the transaction authorization request message:
generating, by the computer server, the secondary password responsive to receiving the restriction request message via the network node that is outside of the payments network such that the secondary password is associated with the monetary restriction for the secondary account;
marking the secondary account for authentication by the secondary password responsive to generation thereof; and
transmitting, from the computer server via a network node outside the payments network, the secondary password to a device identified based on content of the restriction request message.

9. The method of claim 8, wherein the secondary password is a one-time password, and further comprising:
creating the data structure to logically associate the secondary password with the monetary restriction for the secondary account that was received from the consumer device via the network node that is outside of the payments network; and
storing the data structure in the database that is accessible to the computer server.

10. The method of claim 5, wherein the identifying comprises:
identifying, by the computer server, the identifier of the secondary account included in the transaction authorization request message as a token that was previously generated by the computer server to associate the secondary account as a sub-account of the primary account.

11. The method of claim 10, further comprising the following prior to receiving the restriction request message:
generating, by the computer server, the token as the identifier for the secondary account;
creating a data structure that logically associates the token with the secondary account as the sub-account of the primary account;
storing the data structure in a database that is accessible to the computer server; and
transmitting, via a network node that is outside of the payments network, a message comprising the token to a device associated with the secondary account,
wherein the identifying comprises accessing the data structure in the database responsive to receiving the transaction authorization request message to identify the identifier of the secondary account as the token.

12. The method of claim 10, wherein the token comprises a resource locator identifying the computer server, and wherein the computer server comprises an authorization server that transmits the authorization response message to an issuer of the primary account that is communicatively coupled to one of payment nodes.

13. The method of claim 12, wherein transmitting the authorization response message comprises:
generating, by the authorization server, the authorization response message by replacing the token included in the transaction authorization request message with an identifier of the primary account that was generated by the issuer; and
transmitting, from the authorization server, the authorization response message for the electronic transaction between the merchant terminal and the primary account to the issuer of the primary account.

14. The method of claim 13, wherein the transaction authorization request message further comprises a monetary amount provided by the merchant terminal, and wherein transmitting the authorization response message to the issuer of the primary account is responsive to determining, at the authorization server, that the monetary amount does not exceed the monetary restriction for the secondary account.

15. The method of claim 14, further comprising:
preventing transmission of the authorization response message to the issuer of the primary account responsive to determining, at the authorization server, that the monetary amount provided by the merchant terminal exceeds the monetary restriction for the secondary account.

16. The method of claim 5, wherein:
the monetary restriction comprises one of a plurality of transaction restrictions for the secondary account received in the restriction request message from the consumer device via the network node that is outside of the payments network;
the authorization response message indicates authorization for the electronic transaction between the merchant terminal and the primary account subject to the transaction restrictions for the secondary account; and
the secondary account comprises one of a plurality of secondary accounts associated with the primary account, each of which is associated with respective transaction restrictions by a respective data structure stored in the database.

17. A computer program product, comprising:
a computer-readable storage medium having computer-readable program code embodied therein that, when executed by a processor of a computer server, causes the processor to perform operations comprising:
receiving, by the computer server via a network node that is outside of a payments network comprising a plurality of payment nodes, a restriction request message comprising a monetary restriction for a secondary account from a consumer device;
receiving, by the computer server via the payments network, a transaction authorization request message comprising an identifier of the secondary account and a secondary password provided by a merchant terminal that is communicatively coupled to one of the payment nodes;
identifying, by the computer server, the secondary account as being associated with a primary account based on the identifier included in the transaction authorization request message;
performing, by the computer server, authentication for an electronic transaction between the merchant terminal and the primary account based on the secondary password responsive to the identifying; and
selectively transmitting, from the computer server via the payments network, an authorization response message for the electronic transaction between the merchant terminal and the primary account based on the monetary restriction for the secondary account responsive to the authentication based on the secondary password.

18. The computer program product of claim 17, wherein the computer-readable program code, when executed by the processor, causes the processor to perform the authentication for the electronic transaction between the merchant terminal and the primary account based on the secondary password and independent of a primary password associated with the primary account.

19. The computer program product of claim 18, wherein, responsive to the identifying the secondary account as being associated with the primary account and prior to the transmitting the authorization response message, the computer-readable program code, when executed by the processor, causes the processor to perform operations comprising:
accessing a data structure stored in a database that is accessible to the computer server to determine the monetary restriction for the secondary account, which was received from the consumer device via the network node that is outside of the payments network; and
generating the authorization response message by applying the monetary restriction for the secondary account to the electronic transaction between the merchant terminal and the primary account.

20. The computer program product of claim 17, wherein, in the identifying the secondary account, the computer-readable program code, when executed by the processor, causes the processor to perform operations comprising:
identifying, by the computer server, the identifier of the secondary account included in the transaction authorization request message as a token that was previously generated by the computer server, wherein the token associates the secondary account as a sub-account of the primary account.
